(19) United States
(12) Patent Application Publication
(10) Pub. No.: US 2015/0178472 A1
(43) Pub. Date: Jun. 25, 2015

(54) INTERVENTIONAIRE

(71) Applicants: Diana H. Caldwell, Baltimore, MD (US); Allen Joslin, Groton, CT (US); Zachary Elston, West Haven, CT (US)

(72) Inventors: Diana H. Caldwell, Baltimore, MD (US); Allen Joslin, Groton, CT (US); Zachary Elston, West Haven, CT (US)

(21) Appl. No.: 14/571,821

(22) Filed: Dec. 16, 2014

Related U.S. Application Data
(60) Provisional application No. 61/916,605, filed on Dec. 16, 2013.

(51) Int. Cl. G06F 19/00

(52) U.S. Cl. CPC G06F 19/363

(57) ABSTRACT

A computerized web-based system for designing interactive screening and brief interventions targeting risky health behaviors, providing complex content branching sequences based on user inputs, the ability to create readily usable databases from participant responses, the ability to seamlessly incorporate text, audio, images, and video into intervention content, and the dynamic creation of informative graphics based on user response. The surveys are targeted towards individuals who indulge in harmful behaviors such as excessive use of alcohol or drugs. It is used to evaluate and give feedback based on a user's response to a set of questions.

### BACKGROUND OF THE INVENTION

1. Field of the Invention

Interventionaire© lets health care professionals design and implement their own computerized interactive screening, education, and targeted risk reduction interventions that can be deployed early in the care cycle.

2. Description of the Background

A review of the patent literature indicates a range of technology, e.g., online gaming and smartphone applications, to support behavior change therapies. For example, Brown et al. in U.S. Pat. No. 5,879,163 describe an automated system to provide customized health education to induce health-related behavior change. Hester (US 2011/0250576 A1) describes a similar system for helping people to abstain from addictive behaviors. There is also the Health Hero Network's (U.S. Pat. No. 6,210,272) multiplayer interactive electronic game for health education, as well as Entertainment Science's (U.S. Pat. No. 6,561,811) drug abuse prevention computer game.

### SUMMARY OF THE INVENTION

Interventionaire© is a computerized web-based system for designing interactive screening and brief interventions targeting risky health behaviors. The capabilities of the system include: graceful handling of complex content branching sequences based on user inputs; the ability to create readily usable databases from participant responses to questions; ability to seamlessly incorporate text, audio, images, and video into intervention content; customizable presentation formats; dynamic creation of informative graphics based on user inputs to questions. The computerized screening and brief intervention is designed for delivery on portable tablet computers, with the specific consideration that the program be suitable for use in a variety of medical contexts without requiring major disruptions in clinical operations.

Interventionaire© is a software program which is primarily used to build and administer preventative health surveys. These surveys are usually targeted towards individuals who indulge in abusive and harmful behaviors such as use of excessive amounts of alcohol, cocaine or other abused substances. It is used to evaluate and give feedback based on a user's response to a set of questions. First, the user answers questions such as: “On how many days did you drink alcohol?” or “On how many days did you have five or more drinks in the last 30 days?” The respondent is given feedback based on their answers to the questions about themselves and what they perceive other people's usage level to be.

The survey designer can use charts, images or educational videos to inform the user about their habits that do not follow the norm, and ultimately motivate them to make a change in their lives. The survey is completely anonymous. It collects information as directed, for example: the race, gender, and age of each participant as well as their preferred time of day to drink. An internal database is created of screening information collected from user responses. All user responses are stored such that they can be readily incorporated into content allowing for targeted feedback based on respondent characteristics.

### BRIEF DESCRIPTION OF THE DRAWINGS

FIG. 1 shows a representation of the flow of a simple screening.

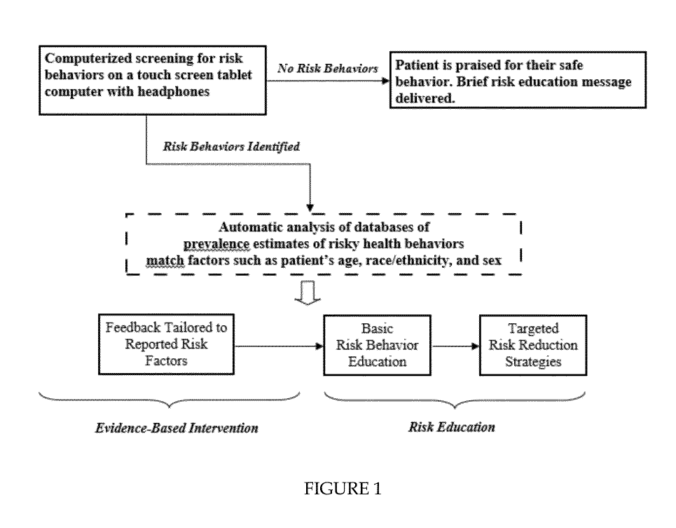

FIG. 2 is representation of the hierarchical structure of a screening.

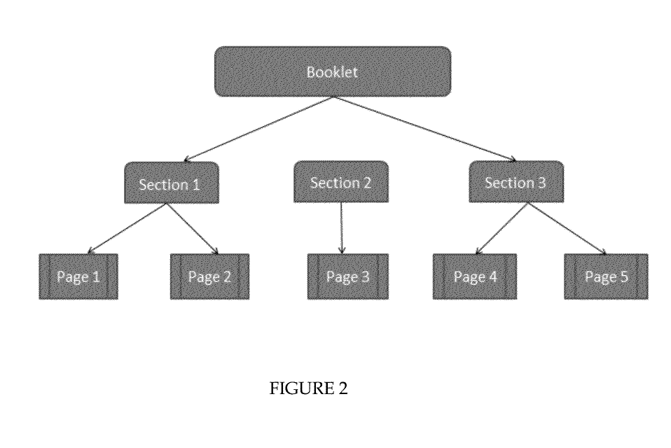

FIG. 3 is a representation of a computer screen that might be presented to a user by the software to log in.

FIG. 4 is a representation of a computer screen that might be presented to a user preparing to create pages.

FIG. 5 shows a palette that might be presented to a user to perform functions while creating pages.

FIG. 6 is a representation of a dialog that provides options to describe the page size and color for a survey.

FIG. 7 is a representation of a menu that provides a list of previously created pages for a survey.

FIG. 8 is a representation of a method for accessing the block menu for a page in a survey.

FIG. 9 is a representation of a menu that provides options for input and output blocks that can be places on pages for a survey.

FIG. 10 is a representation of a process for adjusting the size of blocks on pages for a survey.

FIG. 11 is a representation of a computer dialog that might be presented to the user as a way to edit text in textual output blocks.

FIG. 12 is a representation of a computer dialog that provides options for radio button group input blocks—including the display and value terms.

FIG. 13 is a sample of the invention system survey page containing an output text block and an unstyled radio button input block.

FIG. 14 is a sample of the invention system survey page containing an output text block and a styled radio button input block.

FIG. 15 is a representation of a computer dialog that provides options for slider input blocks—special attention is being called to the configuration of the named value which will be used to access the users' eventual input

FIG. 16 is a sample of the invention system survey page containing an output text block and a styled slider input block

FIG. 17 is a representation of a computer dialog that provides options for checkbox input blocks.

FIG. 18 is a sample of the invention system survey page containing an output text block and several styled checkbox input blocks.

FIG. 19 is a representation of a computer dialog that provides options for textual input blocks.

FIG. 20 is a sample of the invention system survey page containing an output text block a textual input block

FIG. 21 is a sample of the invention system survey page containing an output text blocks and output image blocks.

FIG. 22 is a representation for a computer dialog that provides options for image output blocks.

FIG. 23 is a sample of the invention system survey page containing an output text blocks using several named variables before translation.

FIG. 24 is a sample of the invention system survey page containing an output text blocks using several named variables after translation.

FIG. 25 is a representation of an example dataset.

FIG. 26 is a representation of an example of CSV file.

FIG. 27 is a representation of a computer screen that might be presented to a user to create linkage to a dataset source in a survey.

FIG. 28 is a representation of a computer dialog that might be presented to a user to name a dataset source for a survey.

FIG. 29 is a representation of a computer dialog that might be presented to a user to specify a location for an external data source.

FIG. 30 is a representation of a computer screen that might be presented to a user to create a Section from pages, attention is being called to the method by which a new page is added.

FIG. 31 is a representation of a computer dialog that might be presented to a user to create a name for a new Section.

FIG. 32 is a representation of a computer screen that might be presented to a user to manipulate the inclusion/exclusion of pages from a section, note that the section is unlocked and therefore editable.

FIG. 33 is a representation of a computer screen that might be presented to a user to create a Booklet from Sections.

FIG. 34 is a representation of a computer screen that might be presented to a user to manipulate the inclusion/exclusion of sections from a booklet, note that the booklet is unlocked and therefore editable.

FIG. 35 is a representation of a computer screen that might be presented to a user to select branch descriptions for modification within a Booklet for a survey, note that the booklet is unlocked and therefore editable—attention is being called to the method by which branch definitions are opened for editing.

FIG. 36 is a representation of a computer dialog that might be presented to a user to edit branch descriptions for Sections within a Booklet for a survey.

FIG. 37 is a representation of a computer dialog that might be presented to a user to create dataset evaluations for Sections within a Booklet for a survey.

FIG. 38 is a representation of a computer dialog that might be presented to a user to manipulate branch descriptions for Sections within a Booklet for a survey.

FIG. 39 is a representation of a section of a computer screen that might be presented to a user to select branch types for Sections within a Booklet for a survey.

FIG. 40 is a representation of a computer screen that might be presented to a user to map a created survey.

FIG. 41 is a representation of a survey map showing no branches.

FIG. 42 is a representation of a computer screen that might be presented to a user showing previously proctored/administered surveys survey.

FIG. 43 is a representation of a computer screen that might be presented to a user to select a survey to proctor/administer.

FIG. 44 is a representation of a computer screen that might be presented to a user at the start of a survey.

FIG. 45 is a an overview of the invention system design

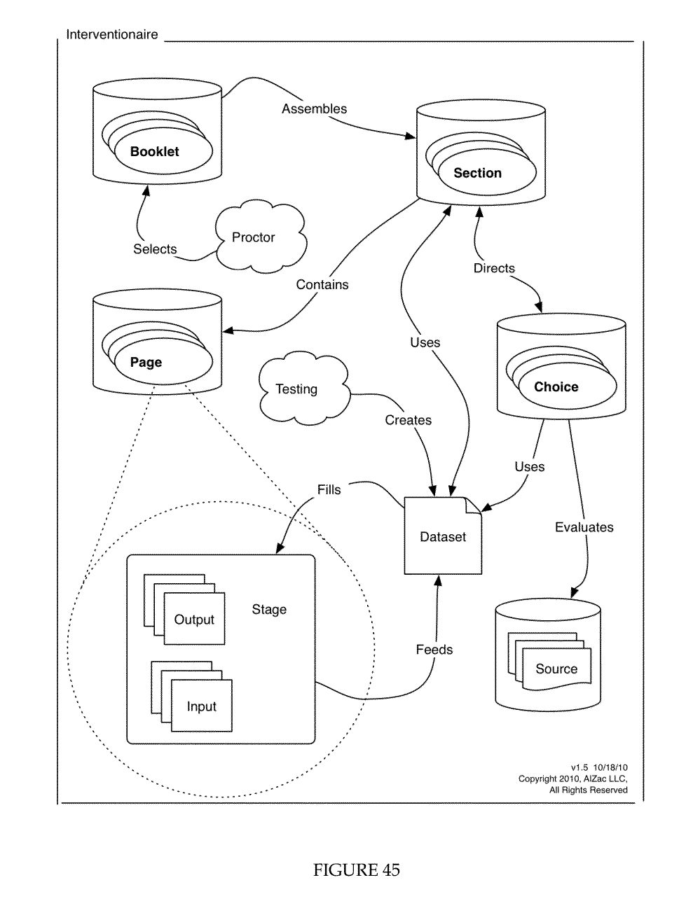

FIG. 46 is an overview of the invention system proctoring process & design

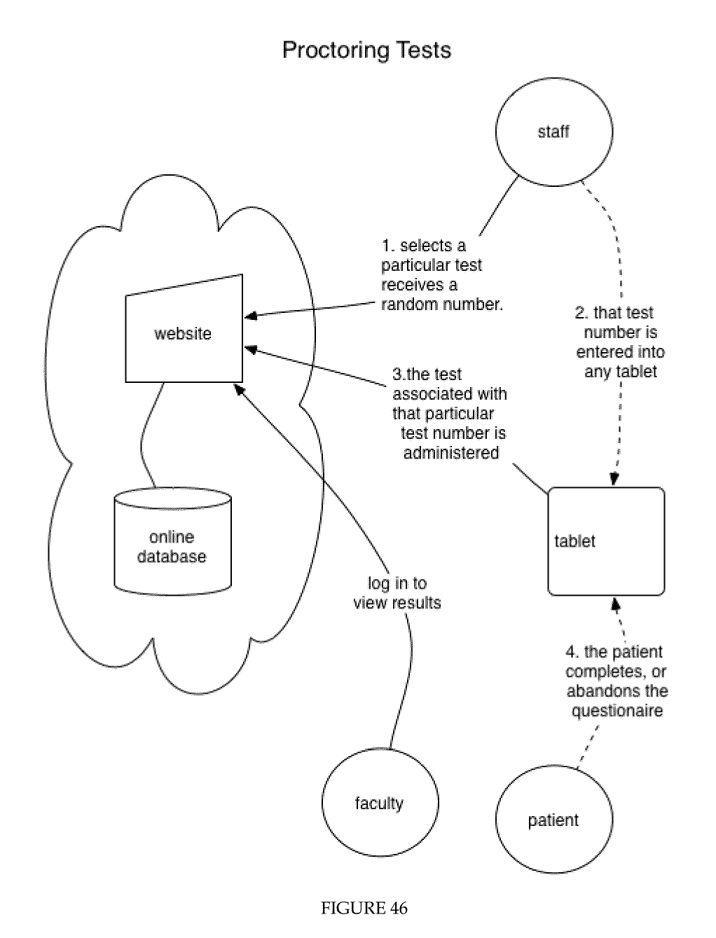

FIG. 47 is an original overview of the User management functions supported by the underlying [open source] safeAjax library that manages the communication between the browser codebase and the server codebase as well as user logins.

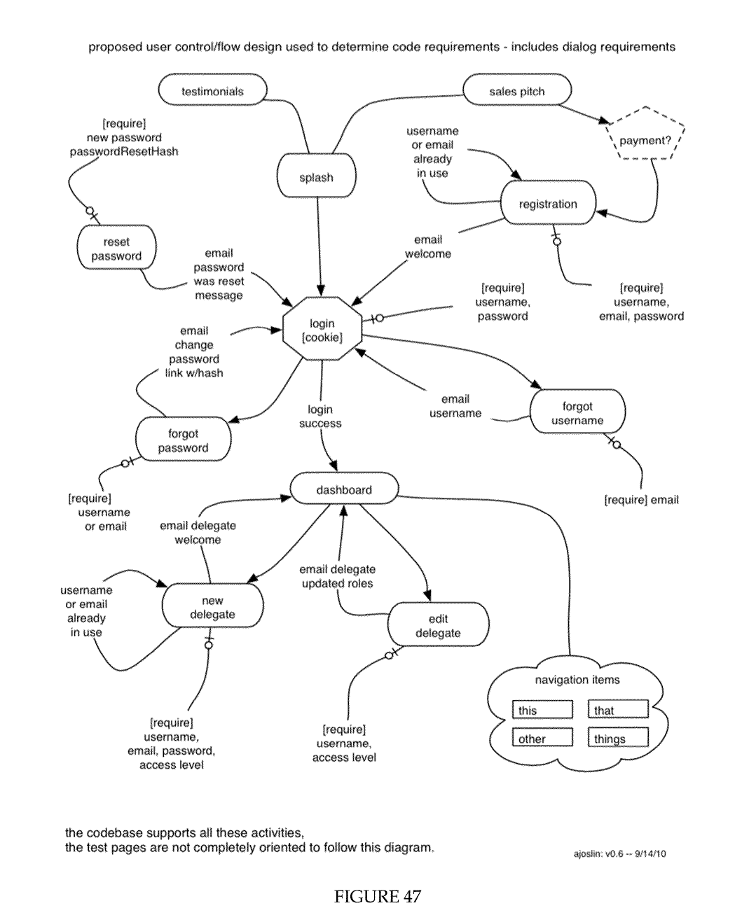

### DETAILED DESCRIPTION

The system of the invention is a web-based computer software product, it has no components that can be used or manipulated outside of the computer. All claims regarding processes and manipulations are to be understood as taking place within the embodiment of the invention computer software screens and dialogs.

For purposes of this document we will use the following terms: patient, the person taking the survey; user, a person operating the invention system software with the intent of preparing a survey booklet to be administered to a patient. Users (with the proper permissions) can also research the datasets that result from the administration of survey booklets to patients.

The main focus of the system product is a page. A page can display information and/or questions to be answered. The system of the invention allows a patient to traverse a self-directed path through a superset of pages. A self-directed path is quicker as it doesn't have to visit all of the content in order to be effective.

The system of the invention presents the user with a free-form page building interface. The page building interface allows the user to place their informational content as they please. The interface allows the user to place their data gathering controls as they please as well. In all cases the content is at the complete control of the user. The system of the invention places no restrictions on what content is displayed on pages.

The system of the invention allows the user to order their pages as they desire. There are no restrictions placed on which pages must be displayed before others.

The system of the invention allows the user to identify variable, dynamic information by applying a name to it. These named variables can be inserted into any textual device within the product. If the named variable does not exist it renders as an empty string rather than an error message. If the named variable does exist, its associated value replaces it in the textual stream. This evaluation of named variables is not recursive in this version of the invention. Named variables are bounded by a unique string of characters, in this implementation double-underbars are placed both before and after the variable names—but any unique string could be used.

The system of the invention allows the user to define the variables to be used to store user inputs using a variety of input devices: textual input boxes, radio button groups, checkboxes, and sliders (for numerical values.) In the case of the sliders there is a repeating evaluation of the slider's associated label so that the associated named variable can be placed there to give feedback on the slider's movement.

The system of the invention offers a way for users to define arbitrarily sized external datasets, and then to evaluate them (using the existing named variables) for the purpose of adding externally defined named variables. In this way the system supports the importing of normative data sets into the patients self-directed passage through the survey booklet.

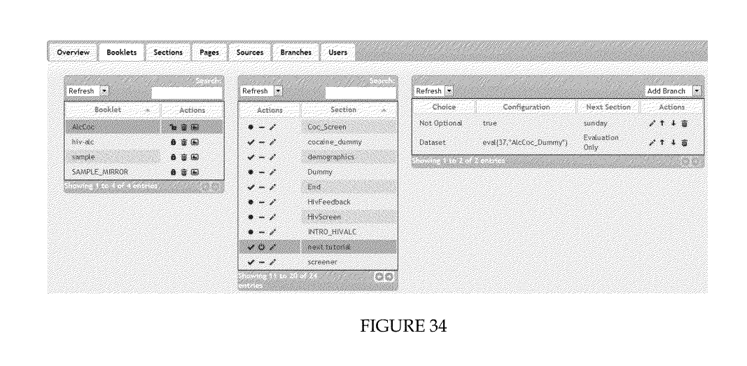

The system of the invention supports multiple branching options at the end of every section. A section being defined as an un-interruptible set of ordered pages of any length, usually culminating in several questions. At the end of each section the user may insert branching logic to evaluate the patient's responses to dynamically determine the next section that the patient should be shown. This branching logic is only limited by the requirement that any branching expression evaluate to a boolean true or false. A graphing feature (FIG. 34) supports the presentation of a visual representation of the survey booklets that can be helpful to the user in understanding the possible paths that a patient may take during the survey.

The system of the invention supports both immediate and deferred reporting on all of the named variables that may be generated during a patient's time within a survey. These results are presented in a tabular format with each named variable as a column header and the associated value(s) as the column data.

The system of the invention supports the creation/maintenance of survey booklets via a web-app. An HTML5 compliant browser is required to operate the software. A minimum screen size of 1440×900 pixels is recommended to effectively utilize the survey booklet editor software.

The system of the invention presents the user with a free-form page building experience. Informational content and data gathering controls may be placed and styled anywhere on the page. In all cases the content is at the complete control of the user. The system of the invention places no restrictions on what content is displayed on pages. The size of the pages is controlled by the user, and is usually the same size as the devices that will be used to administer the surveys. The system content does not dynamically resize or re-flow to fit the screen of the physical device used to display the survey.

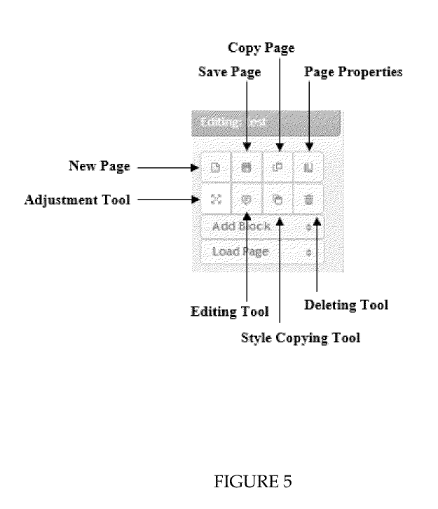

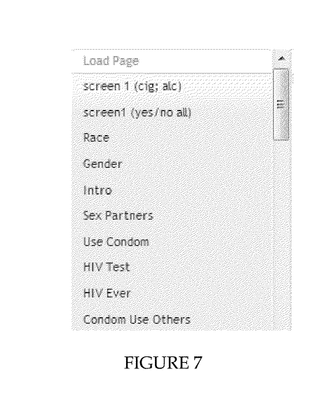

The system of the invention supports four on-page functions (FIG. 5) and a page selection feature (FIG. 7). These operations do not modify the contents of the pages in any way; they operate on pages as indivisible units.

The New Page function abandons the page currently being edited in favor of an entirely new page. If there are unsaved changes to a page that will be lost due to this action then a ‘save your changes?’ dialog is presented prior to any data loss.

The Save Page function will save any changes made to the current page.

The Copy Page function will make a duplicate of the current page and ask the user what name it should be stored under.

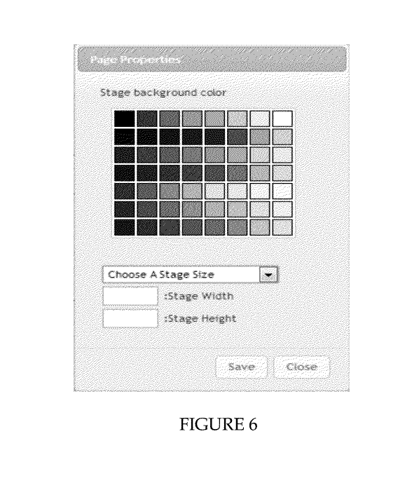

The Page Properties function will present a dialog (FIG. 6) that allows the user to select the page size and an optional background color.

The Page Menu (FIG. 7) gives the user access to their library of saved pages. Selecting a page by name will abandon the current page and load the selected page. If there are unsaved changes to a page that will be lost due to this action then a ‘save your changes?’ dialog is presented prior to any data loss.

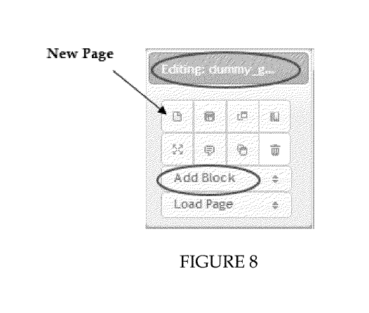

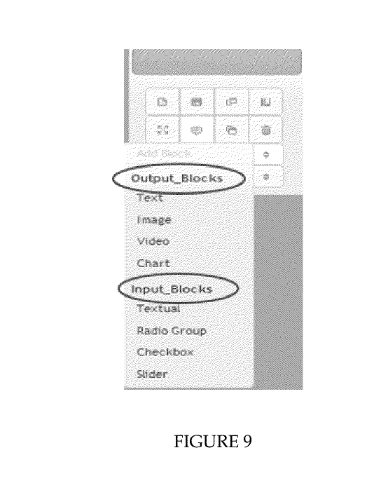

The system of the invention supports four block functions (FIG. 8) and a new block creation menu (FIG. 9). None of these functions will rename, reassign, or reload the page that the user is currently editing.

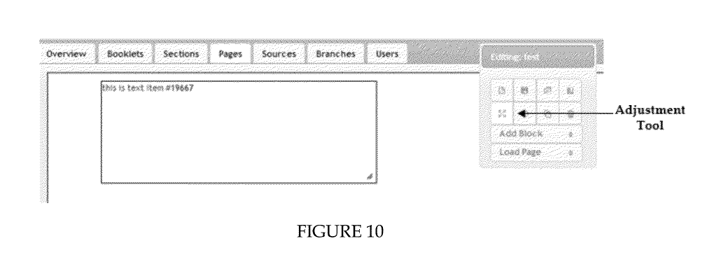

The adjustment tool (FIG. 10) allows the user to click and drag any on-page block to adjust its size or location on the page.

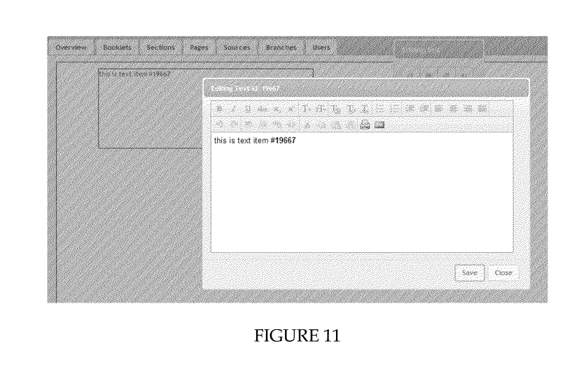

The editing tool (FIG. 5) allows the user to select on-page blocks, once selected any editable options are presented within a dialog box (FIG. 11).

The style copy tool allows the user to apply the text styles already in use for one block to another by dragging the source block onto the destination block. No blocks are moved, resized, or have their content changed by this action—only the text styles are copied from the source into the destination.

The deletion tool lets the user delete any block they click with this tool. There is no warning dialog as the user need only close the file without saving changes to bring back the deleted block.

The block menu lists all the possible blocks, both input and output, which may be added to a page. Select the desired type and a new block of that type is created on the page at the center of the page.

Input blocks are for binding patient entries to named variables. If an input block re-uses a named variable that was previously used on a subsequent page that value is used as the current value. This allows the user to design a page where the patient may update their earlier entries.

Each instance of an input block is bound to a single named variable, patient interaction with any given input block will only affect the value of a single named variable.

Textual input blocks are limited to a single line of text. The associated label may be positioned to the left or right of the control.

Radio input blocks are limited to set of from two to nine radio buttons. Each radio button has a value which may be set independently of the label that is presented to the patient. The associated label may be positioned to the left or right of the control.

Checkbox inputs will resolve to a string which will evaluate to a boolean true or false. The associated label may be positioned to the left or right of the control.

Slider inputs are the most complex of the input blocks. Slider inputs are restricted to integer inputs. They accept an initial default value, as well as minimum and maximum values. To facilitate the patient in selecting an exact numerical answer the labels of slider input blocks are re-processed for named variable substitution every time the slider generates a change event. The associated label may be positioned to the left or right of the control.

Output blocks are for displaying content only, patient interaction with them does not generate or modify any named variables.

Text output blocks are not limited in size, and are given a full complement of styling options including font choices, font size, bold/italic/underline/strikethru/super&subscript, foreground color/backgroundColor&hilightColor, justification, bulleted/numbered lists, indented/outdented paragraphs, and horizontal lines.

Image output blocks are restricted to displaying images via URLs. The user can choose from three sizing options, uses source image width, use source image height, or use containing block size.

Video output blocks are restricted to displaying videos via URLs. The user can choose from three sizing options, uses source image width, use source image height, or use containing block size.

Chart output blocks are the most complex output blocks as their options are quite extensive. Charts require a data source, which the user should define in the source editor [ref: 16000] prior to attempting to add a chart block to a page. There are four types of charts supported: bar, line, fill-to-zero (or shaded), and pie. Each chart has associated configuration options that are entered by the user and passed directly to the charting software.

The charting software in use is an open source package named: jqPlot version 1.0.8—all configuration options available for that version are available on the jqplot.com website.

The invention system pages are stored within the database as an hex-encoded string, this allows pages to contain anything that the user desires as a single block of transmission-safe data which is decoded by the browser before displaying for the user/patient.

The hex-encoded strings contain an array of input and output blocks, as described by their outer HTML attribute (as presented when the page was last saved,) this includes its size & position.

Before each blocks' html is requested from the browsers DOM storage the system software executes a block type-specific function that caches any problematic settings into custom html attributes.

Before each blocks' html is injected back into the browsers DOM storage for rendering the system software executes a block type-specific function that extracts any problematic settings from the custom html attributes they were cached in when stored.

The invention system section editor is used to select and order an arbitrary number of pages from among the superset of all known pages.

All sections are stored under unique names. Each section has an internal id number which is never displayed to the user. Sections can be saved or renamed as long as the new name does not collide with an existing name. The list of sections is presented in a sortable and filterable table.

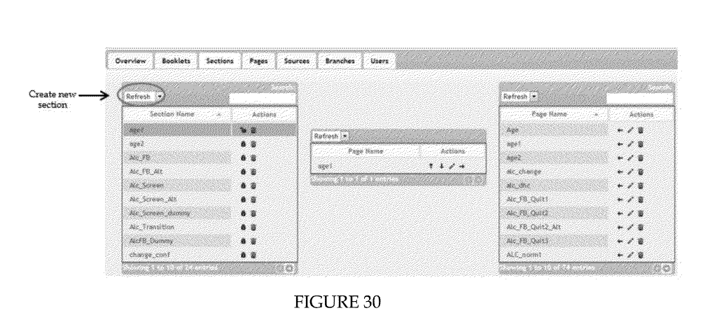

The invention system section editor's interface (FIG. 30) is composed of three lists. The leftmost list is the list of known sections. The center list displays an ordered list of pages that are in the currently selected section. The rightmost list displays a list of all known pages.

The user selects a section by clicking on it in the leftmost list. Once a section is selected the pages that compose that section are loaded into the center list for viewing. In further descriptions the currently selected section will be referenced as the working section.

The user must unlock the working section before being allowed to make changes to the pages included or their ordering. Clicking the padlock on the same line as the working section will unlock it, thus signifying that section is editable. Only one section may be unlocked at a time, unlocking a section will lock any previously unlocked section.

Locking a section will result in a dialog asking if the user wishes to save their changes if any changes had been made to the section while it was in an unlocked state. If the user chooses not to save their changes then they are lost and not retrievable.

Deleting a section is accomplished by clicking on the trashcan icon next to the name of the section that is to be deleted. If clicked then a dialog asking if the user is sure they wish to delete the section is presented. If the user continues and deletes the section it is not retrievable.

Within the center list showing the pages currently included in the working section there are two icons (an up-arrow and a down-arrow) which can be used to move pages up and down in the list. The order of the pages in the list when the section is saved is the order in which the pages will be presented to the patient.

The center list has a right-arrow icon that will move that page out of the working section. The rightmost list has a left-arrow icon that will move that page into the working section.

Both the center list and the rightmost list have pencil icons that are shortcuts to edit that page. Clicking the pencil icon will move the focus to the page editor and load the page whose pencil icon was clicked.

The rightmost list has trashcan icons that allow the user to delete pages. If clicked then a dialog asking if the user is sure they wish to delete the page is presented. If the user continues and deletes the page it is not retrievable.

The invention system booklet editor is used to select and order an arbitrary number of sections from among the superset of all known sections.

All booklets are stored under unique names. Each booklet has an internal id number which is never displayed to the user. Booklets can be saved or renamed as long as the new name does not collide with an existing name. The list of booklets is presented in a sortable and filterable table.

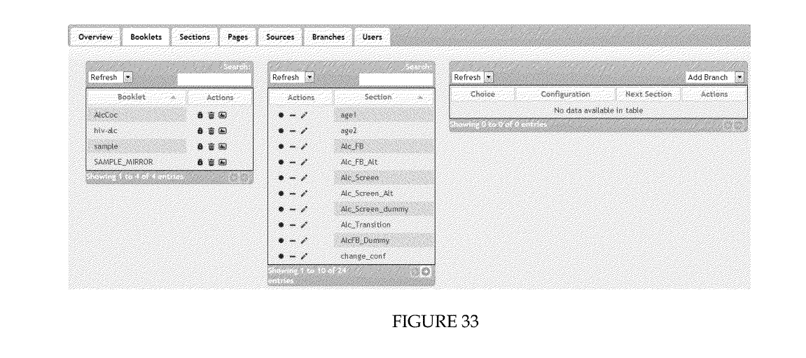

The invention system booklet editor's interface (FIG. 33) is composed of three lists. The leftmost list is the list of known booklets. The center list displays the list of known sections. The rightmost list displays a list of the branching options appended to the currently selected section in the center list.

The user selects a booklet by clicking on it in the leftmost list. Once a booklet is selected the sections that compose that booklet are loaded into the center list for viewing. In further descriptions the currently selected booklet will be referenced as the working booklet.

The user must unlock the working booklet before being allowed to make changes to the sections included or their ordering. Clicking the padlock on the same line as the working booklet will unlock it, thus signifying that booklet is editable. Only one booklet may be unlocked at a time, unlocking a booklet will lock any previously unlocked booklet.

Locking a booklet will result in a dialog asking if the user wishes to save their changes if any changes had been made to the booklet while it was in an unlocked state. If the user chooses not to save their changes then they are lost and not retrievable.

Deleting a booklet is accomplished by clicking on the trashcan icon next to the name of the booklet that is to be deleted. If clicked then a dialog asking if the user is sure they wish to delete the booklet is presented. If the user continues and deletes the booklet it is not retrievable.

Within the center list an action icon is used to show which sections are currently included in the working booklet. An action icon that toggles between a bullet and a checkmark indicates that sections' inclusion in the booklet. In further descriptions the currently selected section will be referenced as the working section.

Within the center list an action icon is used to show which section is to be considered the first section of the working booklet. An action icon that toggles between a dash and the power symbol indicates which section is the first section to be shown in the booklet. Only one section can be set as the first section, setting any section as the first section will de-select any other section from the first position. This icon only works when the section is included in the booklet as shown by a check mark icon.

The center lists a pencil icon that is a shortcut to edit that section. Clicking the pencil icon will move the focus to the section editor and load the section whose pencil icon was clicked.

The rightmost list displays the branching options that are appended to the working section. After the section is completely displayed to the patient the branching options are considered to determine which section, if any, is to follow.

For each branching entry in the rightmost list there are two icons (an up-arrow and a down-arrow) which can be used to move the branching options up and down in the list. The order of the branching options in the list when the booklet is saved is the order in which the branching options will be considered.

Deleting a branch option is accomplished by clicking on the trashcan icon next to the name of the branch option that is to be deleted. If clicked then the branch option is deleted without a dialog, to recover the branch option discard the changes to the booklet.

For each branching entry in the rightmost list there a pencil icon that is used to open a dialog to edit the branch option.

There are four kinds of branching options to choose from: not optional, boolean, data set evaluation, and custom.

A not optional branching option is used to choose the next section to display without question. The final branching option for each section should always be a not optional branch. As the branching engine cannot know which section might be the last section in the booklet it cannot assume a final state. A section without a destination will end the booklet survey.

A boolean branching option is used to choose the next section to display by evaluating named variables. The evaluation of the entered expression must resolve to a boolean, and if true the selected section will be considered the next section. The language syntax of the branching expression evaluator is javascript.

A data set evaluation branching option is used to add named variables to the booklet dataset without requiring the patient to enter the values. The primary use is to bring in normative datasets to assist with the determinations of which sections to show next, as well as to dynamically increase the amount of data that may be displayed to the patient with a high degree of specificity to that patient's situation. The datasets that can be used in these types of branching options are maintained within the invention system's source editor. During data set evaluation the patients working set of named variables is used to most accurately match a single row of the external data set. All remaining columns are then added as named variables to the working dataset.

Custom branches (maintained in the branch editor would allow creators of external normative data sets to create and maintain the branching sets that were intended to be used with the normative data sets.

The invention system branch editor is used to create branching templates; it is expected that the primary use of this editor will be by external normative data set editors.

All branches are stored under unique names. Each branch has an internal id number which is never displayed to the user. Branches can be saved or renamed as long as the new name does not collide with an existing name. The list of branches is presented in a sortable and filterable table.

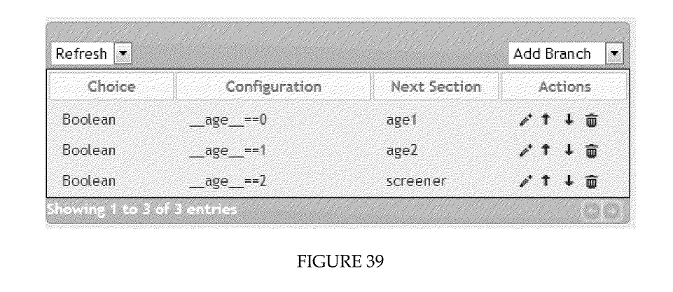

The invention system branch editors interface (FIG. 39) is composed of one list and one editing panel. The leftmost list is the list of known branches. The editing panel is used to describe and define the currently selected branch.

The user selects a branch by clicking on it in the leftmost list. Once a branch is selected the description and definition are entered into the editing panel for viewing. In further descriptions the currently selected branch will be referenced as the working branch.

The user must unlock the working branch before being allowed to make changes to its description or definition. Clicking the padlock on the same line as the working branch will unlock it, thus signifying that branch is editable. Only one branch may be unlocked at a time, unlocking a branch will lock any previously unlocked branch.

Locking a branch will result in a dialog asking if the user wishes to save their changes if any changes had been made to the branch while it was in an unlocked state. If the user chooses not to save their changes then they are lost and not retrievable.

Deleting a branch is accomplished by clicking on the trashcan icon next to the name of the branch that is to be deleted. If clicked then a dialog asking if the user is sure they wish to delete the branch is presented. If the user continues and deletes the branch it is not retrievable.

The invention system source editor is used to create sourcing templates, it expected that the primary use of this editor will be to identify external normative data sets and to create freeform data sets for use by charting output blocks.

All sources are stored under unique names. Each source has an internal id number which is never displayed to the user. Sources can be saved or renamed as long as the new name does not collide with an existing name. The list of sources is presented in a sortable and filterable table.

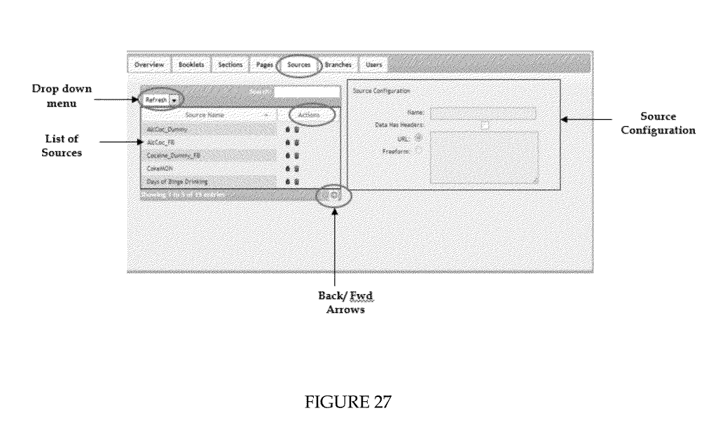

The invention system source editors interface (FIG. 27) is composed of one list and one editing panel. The leftmost list is the list of known sources. The editing panel is used to describe and locate the currently selected source if an URL, and define if a freeform source.

The user selects a source by clicking on it in the leftmost list. Once a source is selected the description and source or definition are entered into the editing panel for viewing. In further descriptions the currently selected source will be referenced as the working source.

The syntax of a freeform source must conform to the data source syntax for the jqPlot data sources. Freeform data sources are only for charting purposes, there is no provision for evaluating freeform sources to add named variables to the patients working data set.

The user must unlock the working source before being allowed to make changes to its description and source or definition. Clicking the padlock on the same line as the working source will unlock it, thus signifying that source is editable. Only one source may be unlocked at a time, unlocking a source will lock any previously unlocked source.

Locking a source will result in a dialog asking if the user wishes to save their changes if any changes had been made to the source while it was in an unlocked state. If the user chooses not to save their changes then they are lost and not retrievable.

Deleting a source is accomplished by clicking on the trashcan icon next to the name of the source that is to be deleted. If clicked then a dialog asking if the user is sure they wish to delete the source is presented. If the user continues and deletes the source it is not retrievable.

The Invention system user editor is used to assign privileges to users.

All users are stored under unique names. Each user has an internal id number which is never displayed to the user. Users' Access levels can be set and their usernames and email addresses can be reset. No password reset functions are available in this editing pane.

The invention system user editors interface is composed of one list and one editing panel. The leftmost list is the list of known users. The editing panel is used to update name and email information about the currently selected user as well as their access level.

The currently logged in user selects a user by clicking on the username in the leftmost list. Once a user is selected their information is entered into the editing panel for viewing. In further descriptions the currently selected user will be referenced as the working user.

Every user in the system of the invention is owned by another on up to the root user for that installation.

Unclaimed users (freshly registered) become owned by the first user that grants them access.

The controls on the user editor are such that the currently logged in user may grant access of a level equal to or less than their own to any owned user.

Below the editing pane a tree-graph is drawn to show the relationships between the currently logged in user and their owned users.

The user must unlock the working user before being allowed to make changes to its description and user or definition. Clicking the padlock on the same line as the working user will unlock it, thus signifying that user is editable. Only one user may be unlocked at a time, unlocking a user will lock any previously unlocked user.

Locking a user will result in a dialog asking if the user wishes to save their changes if any changes had been made to the user while it was in an unlocked state. If the user chooses not to save their changes then they are lost and not retrievable.

Deleting a user is accomplished by clicking on the trashcan icon next to the name of the user that is to be deleted. If clicked then a dialog asking if the user is sure they wish to delete the user is presented. If the user continues and deletes the user it is not retrievable.

Each user has a graphing icon that will redraw the user hierarchy with that user as the root of the tree.

The list of access levels and their descriptions are as follows:

Privileges in this system are arranged in a simple hierarchy, each level of privileges adds more capabilities to your login

The privileges implementation supports delegation, users can decrease/increase(*) permissions of other users

Privileges are used as minimal access-level-required values for code execution privileges are assigned/delegated as maximum available for assignment(*)

*As a delegator, delegation is to within 1 pt of their own privilege. i.e., someone can't delegate control over themselves

| min | max | privilege |
|---|---|---|
| 1 | 1 | New Registrant |
| 2 | 99 | Proctoring |
| 100 | 199 | Saving Source Changes |
| 200 | 299 | Saving Page Changes |
| 300 | 399 | Creating Pages |
| 400 | 499 | Saving Section Changes |
| 500 | 599 | Creating Sections |
| 600 | 699 | Saving Booklet Changes |
| 700 | 799 | Creating Booklets |
| 800 | 999 | Saving Branch Changes |
| 1000 | 1000 | Booklet Owner |
| 1001 | 1999 | Reseller |
| 2000 | 2999 | Domain Management |
| 3000 | 32000 | System Management |

Booklet owners are the contract holders, they are the invoiced entity. They can delegate everything except paying the bills.

The invention system survey booklets are administered anonymously to the patients.

The user selects a booklet survey to administer and is given a non-predictable, non-repeating id number.

The user enters that non-predictable, non-repeating id number into the computer being used by the patient, or may direct the patient to do so.

There is no provision within the system software to record any meta-information about the non-predictable, non-repeating id number.

The booklet survey proceeds according to the patient entries and the user's booklet definitions until a section ends without a ‘next section’ being defined, at that point the software declares the booklet survey to be completed and finalizes the patient data set into a researchable, historical, non-modifiable data set.

As the patient moves through the booklet survey their inputs are recorded and tagged with the ordinal page number using a stack-type (last on, first off) storage metaphor.

If the patient moves backwards to check work or change answers the inputs are discarded as the pages they were entered on is passed. This is required, as subsequent entries could invalidate previous answers as the patient could take a different path through the booklet survey.

Completed invention system booklet surveys are researched in booklet order.

All patient data sets resulting from a single booklet survey will share a consistent superset of named variables, so the tabulation of these sets will present a regular data set.

The format of research data sets is: a header row where column 1 is ‘id’ and the remaining column headings are the names of the named variables encountered by all the patients in the set of responses. The second and further rows are of the format: column 1 is the id number that was entered at the start of the survey, the second and further columns are the values from the named variables as shown by the column headers.

If the patient did not enter a data value for any particular named variable then no value is defaulted

Provision is made for requesting a .csv version of this data for download and later evaluation

To build a survey, one needs to start with building the pages. The pages then go into sections. A booklet consists of various sections. A respondent will see only the sections that we want them to see. For example, if there are certain pages that ask about a female's reproductive health, only a respondent answering as female will see those pages. This is because, you can ask the user about their gender and direct them accordingly to relevant pages. This is achieved by creating branches at the end of sections. Based on a user's response (male or female) a user can be directed to pages relevant to their specific case.

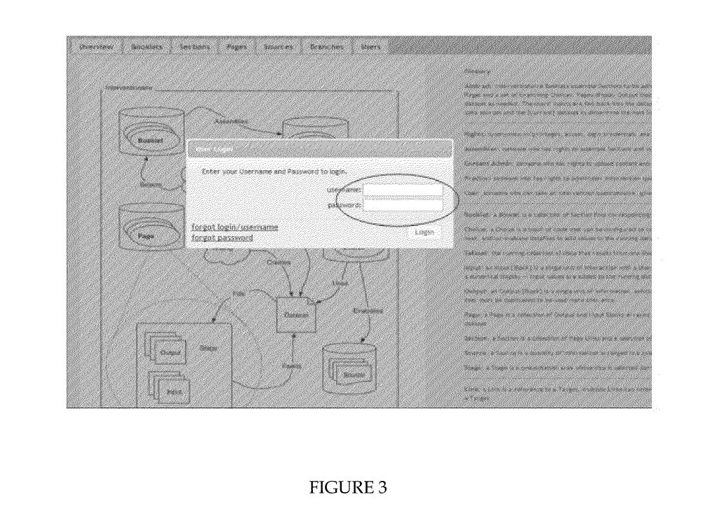

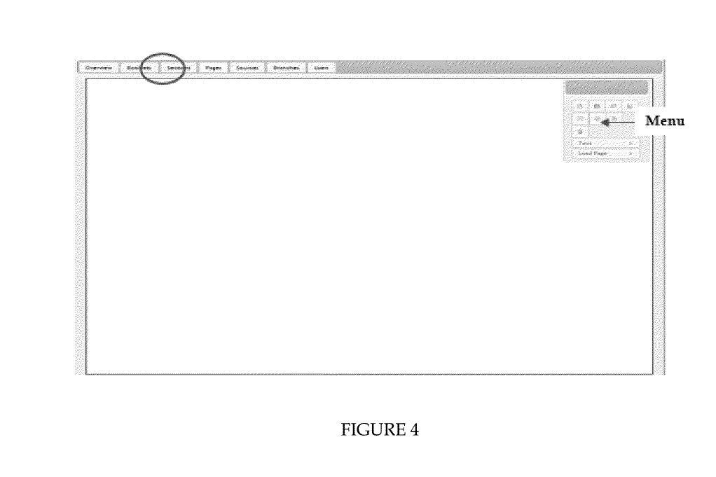

After logging in by entering username and password at a screen shown in FIG. 3, navigate to the ‘Pages’ tab on the top by clicking it. As you can see in the FIG. 4, ‘Pages’ tab is selected. Also note the menu box on the right side of the picture.

FIG. 5 shows the menu box on the right side of FIG. 4 that allows user to perform a variety of functions.

New Page: Used to create a new page.
Save Page: To save any modifications made to a page.
Copy Page: Copy page is a unique feature of this software. If you want to create another page that looks exactly like an already existing page, you can use this feature. This feature is very useful when you are trying to create a lot of pages that have the roughly the same layout. NOTE: Once the new page is created, it is important to hit the “Save Page” button in order to save the changes made to the new page.
Adjustment Tool: Allows you to position an input or output block anywhere on the page and set its size as well.
Editing Tool: It lets you add, edit, and format text.
Style Copying Tool: This is a unique feature of the system of the invention. This tool is used to copy the formatting and style.
Deleting Tool: This tool allows the user to delete any input or output boxes that you create.
NOTE: If you use this tool, the whole block will disappear. To delete a single word, use the Editing tool and then use backspace to delete a single word or a sentence.
Add Block: Allows you to add both input and output blocks.

FIG. 6 shows a representation of the ‘Page Properties’ selection on the menu box. This is a great feature that allows you to set the page background color and the stage size. Stage size option is useful because the surveys can be administered by using various devices such as: ipad, iphone, or netbook. Suggested page size options include:

ipad horizontal 1024×768

ipad vertical 768×1024

iphone horizontal 480×320

iphone vertical 320×480

Netbook: 1024×576

You can also customize the length and width of the page

FIG. 7 shows a representation of the load Page′ selection on the menu box. This feature allows the user to load (display) a previously created page. Once the page is loaded, it can be modified. From the figure, any page name can be clicked to display it.

FIG. 8 shows a representation of a screen that is presented to a user to create a new page. The following steps should be followed to create a new page: Select ‘Create New Page’ from the menu. Click on the option ‘New Page’ as labeled in the figure below. A dialogue box appears; enter the name for the new page: “dummy gender.”

You can see in FIG. 8 that a new page was created and it is displayed at the top of the menu box, “Editing: dummy_g . . . ”

Also pay attention to the button ‘Add Block’ circled in the figure below. The instructions below will show you how to use it.

FIG. 9 is a representation of a computer screen that is presented to user to let them know about different types of blocks that can be added to a survey page. After the page is created, it can be modified to ask a question or get input from the respondent. You can do these things by adding an input block or an output block. Before proceeding, it is necessary to understand the different kinds of input and output blocks and their purpose. An output block can be used for the following:

Text box: Add text to it. Please note that all text on a page will be within an output text block. You will have to edit within a text box. You can use a text box to give instructions or ask a respondent questions.
Image: Add an image to the page
Video: Add a video
Chart: Add a chart. Charts are used to give feedback to the respondents based on their answers to the questions. For example, a chart might compare the alcohol use of the general population with that of the respondent.
To add an output block to the page so that you can ask a question, simply click on ‘Add Block’ from the menu box and select ‘Text’ under ‘Output Blocks.’ A block appears.

FIG. 10 is a representation of a computer screen that is presented to the user after an output block is added to the page. Click on the ‘Adjustment Tool’ button to position the text box on the page. Simply click inside the box and drag it to the desired location. To make the box bigger, click on the bottom right corner and drag it until the box is of the desired size. If you want to make it wider, click on the shorter side and drag. To change the height, drag the bottom of the box.

FIG. 11 is a representation of a computer dialog that might be presented to the user to edit text after clicking on editing tool in FIG. 5. This new window is a text-editor for the box. Click in the window and start typing to add text to it. Type, “Please choose from one of the options below.” Since you want to format the text, use the menu bar at the top of this text box. You can make the following changes to the text by using the buttons.

Bold, Italic, Underline

Strikethrough, Subscript, Superscript

Change Font Style, Font Size, Font Color

Highlight Text, Remove Formatting

Add Bullets (both number and bullet points), Add Indentation to text

Align text: left, center, right, or justified

Undo, Redo

Insert Horizontal Rule, Insert Image, Insert Hyperlink, Remove Hyperlink

Cut, Copy and Paste

Paste as text, Print, and Show HTML

Add radio buttons so that the user can pick an option. Follow the steps below

Add Block—Radio Group (Under ‘Input Block’).

The radio button appears at the top right hand corner of the page. Use the adjustment tool to position it on the page.

Now, create two options with the radio buttons (Female and Male). Do this by clicking on the ‘Editing Tool’ and then clicking on the radio button.

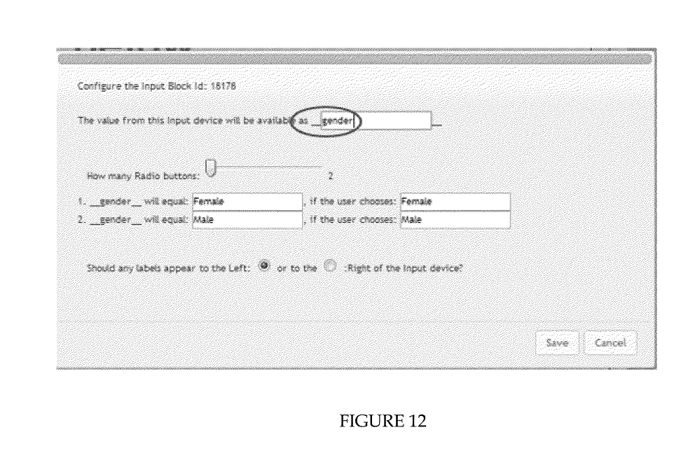

The process described above, brings up a new window as presented in FIG. 12. As shown in the picture, options Female and Male are entered below. The following are the features of radio buttons:

Results are available via the label: _gender_(Use_gender_to create a branch based of off this variable)
Specify the number of radio buttons needed 2-9
Enter the values for each radio button
You can choose which side of the button the label will appear on.
The user has to make sure to save the changes by clicking on the ‘Save Page’ button.

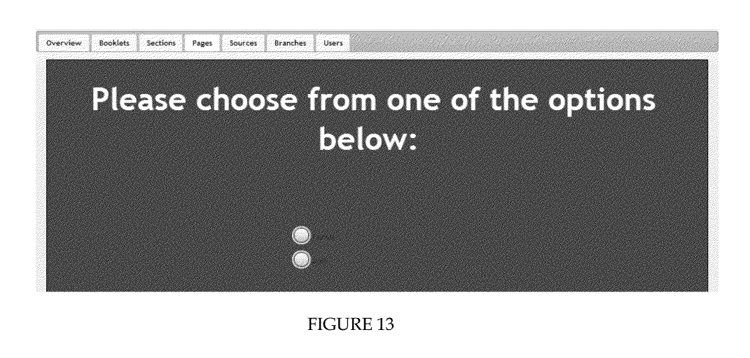

FIG. 13 shows that the text beside the radio buttons is not formatter and is barely readable. This is where the Style Copying Tool is very useful. First, the user would click on ‘Style Copying Tool’ from the menu box. Next, click on the output block and drag its' formatting over to the radio buttons.

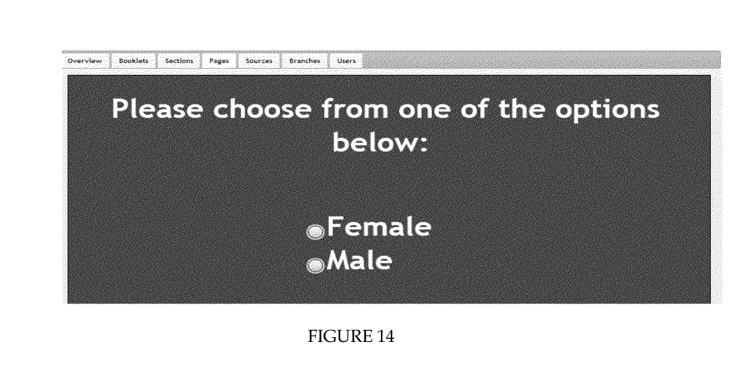

The results are shown in FIG. 14.

You can see that the page now looks nicely formatted
The user can also create another page that is a copy of the page that already exists. In order to do that: Click on the ‘Copy Page’ button.
The user is prompted to enter a name for the new page.
Once the new page is created, click on the ‘Save’ button so that all the changes are saved.

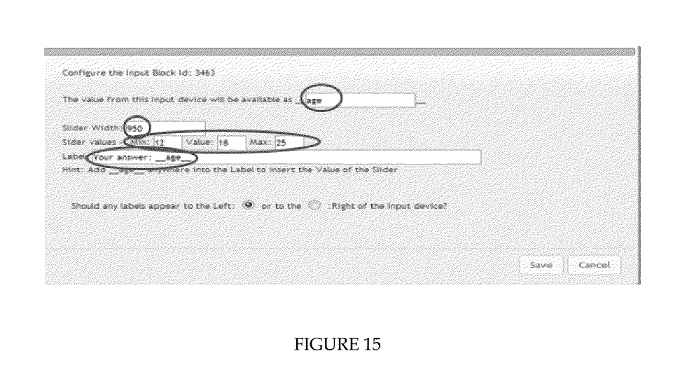

FIG. 15 shows that the same question can also be represented and ask for an input in the form of a slider. Starting from the copy of the page that was just created, the user can do the following to add a slider:

First, edit the text in the text box and add, “Using the slider, please indicate your age below.”
Since you want to add a slider instead of the radio buttons, click on the ‘Deleting Tool’ and then click on the radio buttons on the page.
Using the ‘Add Block’ button, add a slider (under ‘Input Block’) to the page.
Using ‘Adjustment Tool,’ position the slider in the middle of the page and stretch it across the width of the page.
Click on ‘Editing Tool’ and then click on the slider to edit it.
A new window appears. As you can see in the figure above, the values that need to be filled out are circled. You will need to enter those values:
“The value from this input device will be available as” does not take a numerical value. However, a text or a combination of numerical and textual values is acceptable. In this example, ‘age’ is entered as the variable name. NOTE: To use the user-selected values anywhere else from this slider, you will have to use_age_(double underscore-variableName-double underscore) as the placeholder.
Slider width: if you want the slider to spread across the width of the page, specify the length of the slider. A length of 950 was determined by trial and error.
Slider values: You'll have to specify the minimum, default slider value, and maximum slider value.
Enter, “Your answer: _age_” in the label column so that the user can see the value they selected.
Lastly, select where the label should appear on the slider.
Hit ‘Save’ and the slider appears on the page.

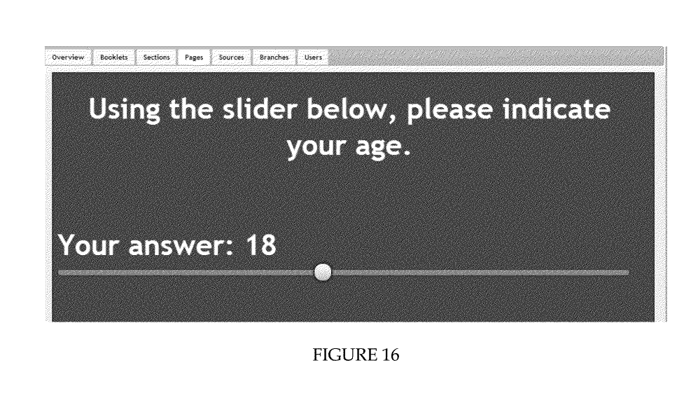

FIG. 16 is a representation of the page created with a slider and use of style copying tool to copy the formatting.

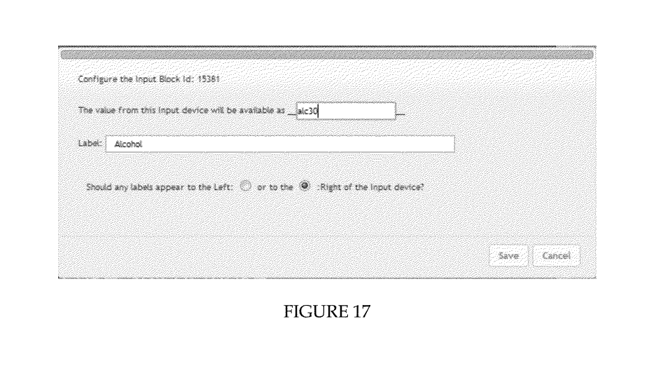

FIG. 17 is a representation of a computer screen that might be presented to the user to assign a variable to an input block to be filled by the respondent. In this case, the user wants to ask the respondent if they have used substances like alcohol, cocaine, amphetamines etc.

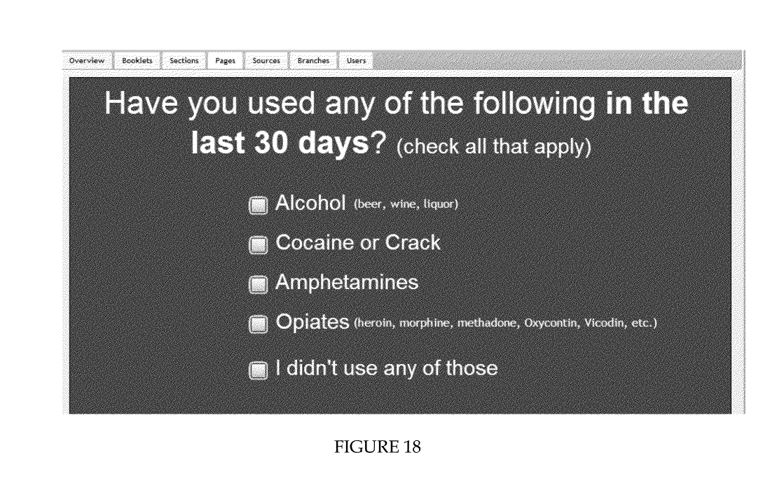

To achieve this the following steps are to be performed:
First, create an output text block to ask the question: Have you used any of the following in the last 30 days?
Next, create checkboxes (under ‘Input Block’). NOTE: You can only create one checkbox at a time. You will have to edit the checkbox by clicking on the Edit button and then clicking on the checkbox.
As you can see in the figure above, the fields have been filled out.
_alc30_is the variable that will allow you to access the value somewhere else in the survey.
The Label field appears next to the checkbox. It is labeled ‘Alcohol.’
Finally, indicate that the label will appear on the right side of the checkbox.
FIG. 18 is a representation of the page created.

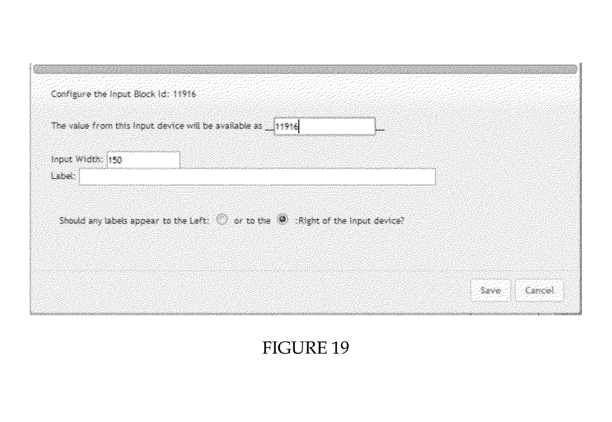

FIG. 19 is a representation of a computer screen that lets the user create a block for the respondent to leave feedback for the survey or answer a question by typing in an answer. An input text block accepts typed answers.

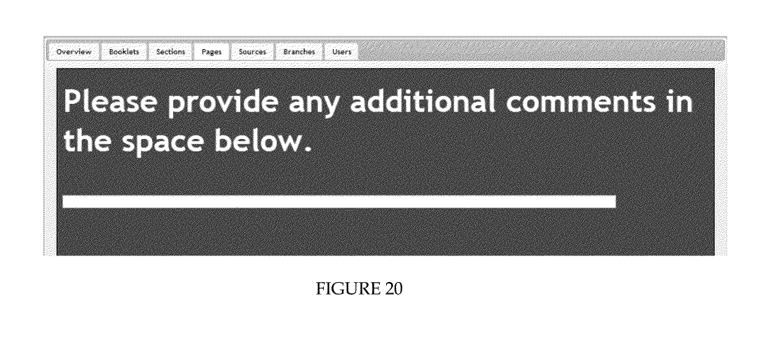

Add a textual input block to the page.
Position it on the page accordingly.
Click on the edit button and then click on the block to edit it.
If you like, you can label the input block. In this example, it is left blank.
FIG. 20 is a representation of the page created.

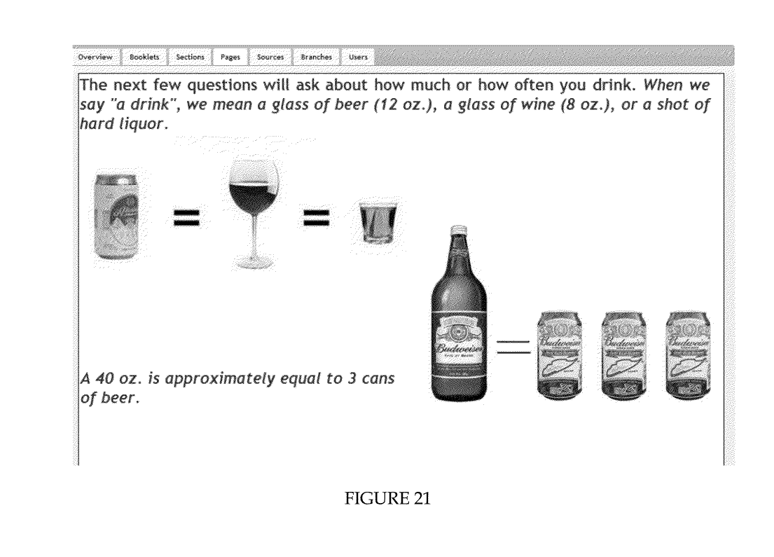

User can also add an image as well as a video to make a page more informative. An image can be used to convey any kind of information. For example, an individual may not know what is meant by a drink. FIG. 21 is a representation of a page with images that is created to help respondents understand better with the help of an image.

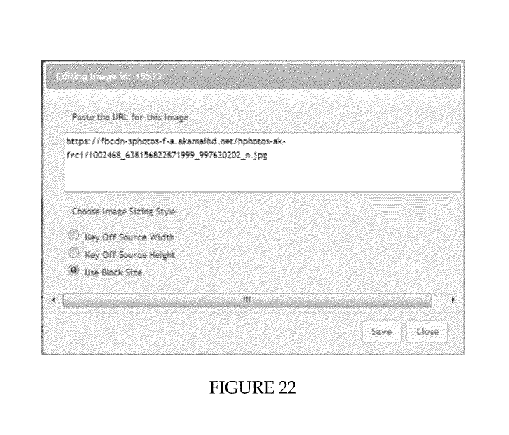

FIG. 22 is a representation of a computer screen that might be presented to the user to add an image or a video. Followings steps should be followed to do so:

To add a picture to a page, click on Output Blocks from the menu box and then select ‘Image’ from the dropdown menu.
Position it on the page using the Adjustment Tool.
Select ‘Editing Tool’ and then click inside the ‘Image box’ on the page.
First, paste the URL of the picture you want to appear on the page. You can see that a URL has already been added to the image. NOTE: You will have to specify a URL for the image. You cannot specify the URL of the page containing the image. In other words, the URL should have a .jpg or a .png in the end.
You can choose the size of the image from the options:

### Key off Source Width

### Key off Source Height

Use Block size
To add a video, follow the steps described above for uploading an image. Make sure that you use the URL of the video and not the page containing the video. Alternatively, you can also upload your videos and images to Research Circle's server and then specify the URL to be used for a picture or a video.

Once the user is asked to answer a variety of questions about their race, gender, age, drinking habits, and drug use (such as alcohol or cocaine), it is time to give feedback. The system's software capabilities allow one to give feedback that is directly relevant to the individuals' answers.

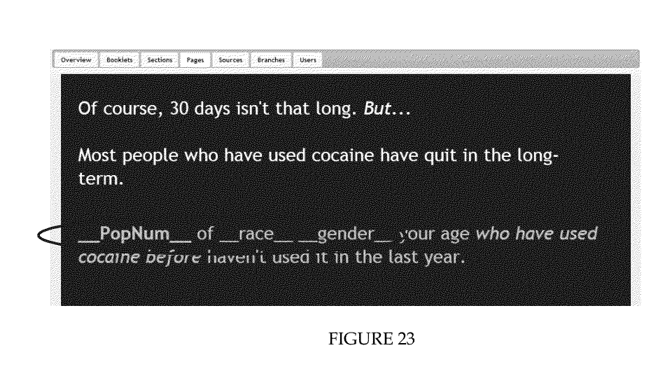

FIG. 23 is representation of a sample feedback page (in Page Builder Mode.

_PopNum_: This is a placeholder for the number of people who used cocaine but haven't used it in the last year.
_race_: Placeholder for respondent's race.
_gender_: Placeholder for the respondent's gender.

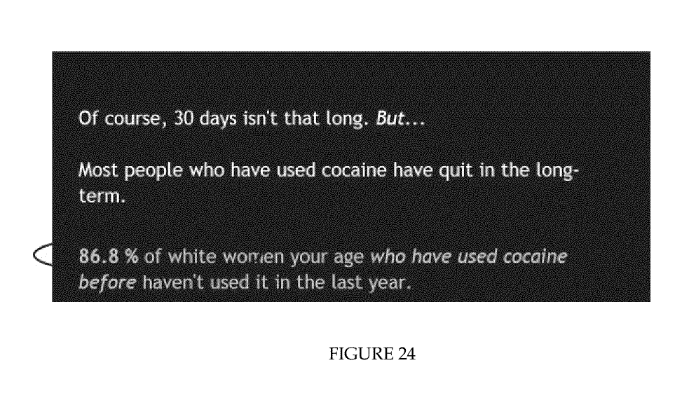

FIG. 24 is a representation of a sample feedback page in survey mode.

_PopNum_has been replaced by a number. This number is retrieved from the dataset and it is matched to the user's values of gender and race. How to upload and use a dataset will be explained later.
_race_has been replaced by the respondent's race.
_gender_has been replaced by the respondent's gender. The system of the invention retrieved the values of race and gender as answered by the respondent in the previous questions. The system of the invention allows for substitution of such values so that feedback given to individuals is directly relevant to them.

Another way of giving feedback to respondents is by using charts. Charts are very useful when delivering feedback to the user/respondent. For example, you could build a chart that compares the consumption habits of an alcoholic to that of the general public. When the user sees the information in a graphic fashion, they are better able to compare their lifestyle with that of others. The system of the invention uses a unique way to pull out the relevant variables from a given dataset. This form of charting is called freeform charting.

Freeform charts—Freeform charts are the most commonly used charts in invention system surveys. A freeform chart utilizes the information entered by the user in the survey; compares it to the national average and presents that information to the user in the form of a chart (bar chart, pie chart etc.). The comparison is made strictly between the user and the average within a user's demographic (that is age, race, and gender).

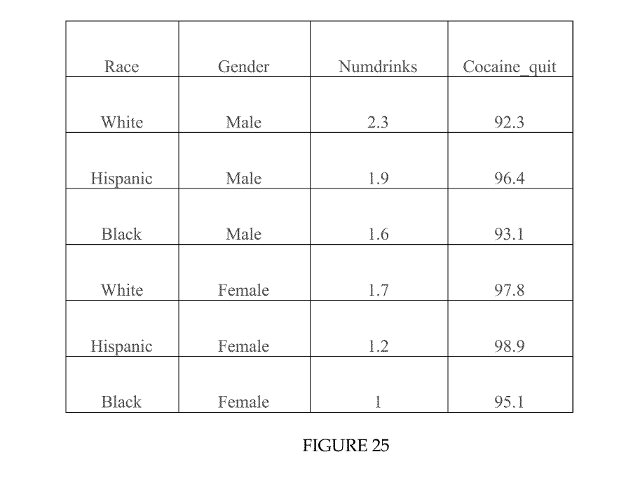

To build a chart, the user must upload a dataset to Research Circle's website. FIG. 25 is a representation of what a sample dataset might look like:

Race and Gender—self explanatory
Numdrinks+Average number of drinks that an individual of that particular race and gender has on a given occasion.
Cocaine_quit—Number of people who have used cocaine previously but have stopped using it in the last year.

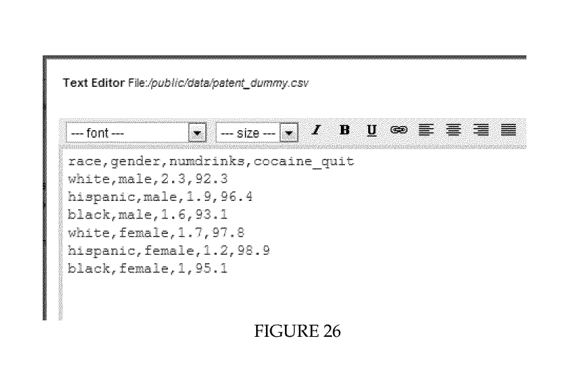

FIG. 26 is a representation of an example of CSV file. The system reads the data from a CSV file. To build a CSV (comma-separated values) file:

Open Excel on your computer.
Enter the data as you would normally enter in an Excel file
Save the file with a .csv extension. For example: ‘YOUR_FILE_NAME.CSV’.
The following figure demonstrates the format of a CSV file.
The CSV file needs to be uploaded to Research Circle's server.

Uploading a source to the invention system is crucial for some surveys. A source is used to give feedback to the user based on their responses to your questions. A source can be of two types: dataset or freeform source. The steps are simple but essential. A dataset source is used to give feedback to the users in a text form. For example, the following text might appear on a feedback page: “96.4% of_race_ _gender_in your age group who have used cocaine before haven't used it in the last 30 days.” Note the following things:

The number 96.4% is being pulled from a dataset source which has been uploaded to the invention system based on an individual's characteristics, such as: race, gender, and age. This is made possible because the survey administered to the user asks questions about the demographics of the user. Those variables are then saved so that they can be used later. When feedback is given to the user, the invention system pulls the numbers that correspond to the user's demographics.
To give feedback to a user in the form of a chart, you need to use a freeform source. From a freeform source, one is able to pull the exact variable(s) based on the user's race, gender, and age. It is not possible to use a dataset source to do the same.

Once the file is uploaded, you can use it to create charts. To create a chart, go to the page where you want the chart

Click on load Page′ and select ‘Chart’ under ‘Output Blocks.’ A block appears on the page.
Position it where you want the chart to appear on the page.
Next, tell the system where it can find the dataset to use when creating a chart. To do this, navigate to the ‘Sources’ tab on the top. As you can see in the figure below, the ‘Sources’ tab is selected.
Sources are of two types.
Dataset source
Freeform sources
Different syntax exists to create a chart with a dataset source or a freeform source.

FIG. 27 is a representation of a computer screen that might be presented to the user to help manipulate the sources and data linkage.

Drop-down menu: on the top left corner of the page. This lets you create new sources.
List of Sources: Contains a list of all the existing sources (for all surveys) within the system of the invention.
Actions: Next, to the ‘Source Name’ list is the ‘Actions’ column. Notice the lock sign and the little trash can sign that appears next to each source. If you click the lock sign next to a source, it unlocks the source so that it can be edited. Similarly, you can click the trash can sign to delete a source.
Source Configuration: Allows you to edit existing sources and is also used to create new ones.
Back/Forward Arrows: Source entries are arranged alphabetically. You can use these arrows to locate your source entry if there are multiple pages of sources and edit it.
The user can select a source (a CSV file). As in the given example, the source file is already created and uploaded to Research Circle's website (FIG. 26).
To create a dataset source, the user needs to be in the ‘Sources.’ Click on the ‘Drop-down’ menu at the top left and click on ‘New.’ The user is asked to enter a name for the new source.

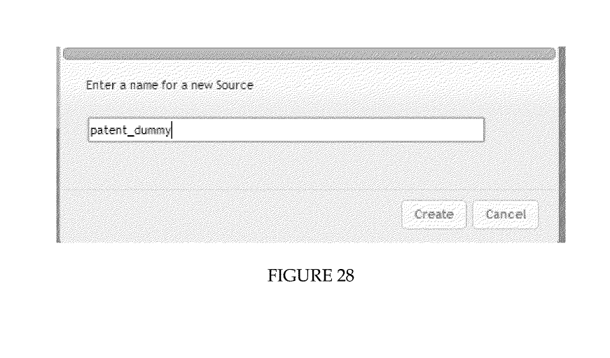

FIG. 28 is a representation of a computer screen that asks the user to enter a name for the new source.

After the name is entered, click on ‘Next’ to create the source.
The user still needs to tell the source where to find the data. Use the Back/Forward arrows (FIG. 27) to navigate to the source entry and edit it. Next, click on the lock sign so as to edit the source. You will notice that the Source Configuration window is now open for editing.

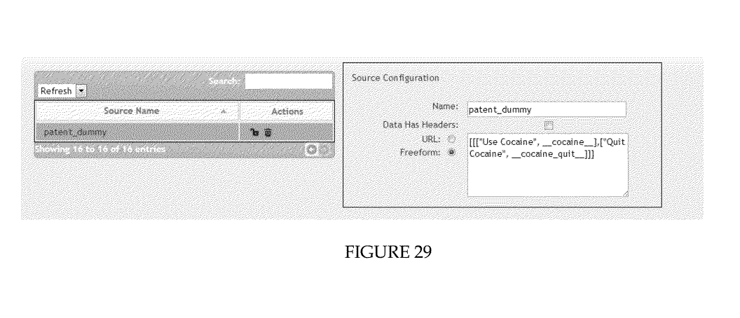

FIG. 29 is a representation of a computer screen where the software allows user to edit the source. It represents the Source Configuration window.

You can see that all the required information has been entered. Notice that the checkbox next to the field ‘Data has Headers’ is not checked. Recall that when you created the CSV file, headers such as: race, gender, cocaine_quit etc were added. That is what meant by “headers” here. However, you will see later why that field is important.
Also notice that ‘Freeform’ is selected because this is the format of the data
Lastly, copy and paste the location of the data file in the window.
To save the changes you made to patent_dummy, click on the lock sign. Your source is finally ready to use!

The user can navigate to the ‘Pages’ tab. It is finally time to create a chart. It is very simple from here on:

Create a new page and name it, ‘Cocaine_Quit_Dummy’.
Click on ‘Add Block’ and add the chart to the page.
Next, place the ‘Chart’ box in the center of the page—right where you want the chart appear.
You can, of course, make other additions to the page (In the final version of the page, you will see some added text.)
Afterwards, click on the ‘Editing Tool’ and then click on the chart box. A new window appears.

EVALUATING A DATA SET: The invention system evaluates the dataset through a CSV (comma-separated values) file. Since you need to give feedback to the users, open a new Excel spreadsheet and enter your data in the spreadsheet. To create a CSV file, simply save the excel spreadsheet as ‘YOUR_FILE_NAME’.CSV

Upload the file to Research Circle's website using File Manager Pro.
If you want to make a minor change to a CSV file, double click the file and make whatever change you wanted to make. Click ‘Save’ and ‘Close.’
There is a slightly different procedure to use a data file in invention system. The primary purpose of a data file is to get the values entered by a user in the survey, match them with a row of data in the CSV file and, present the user with new values.
For example, you may ask the user for their gender and race. Based on these variables you could present the user with the percentage of people (of that gender and race) who quit drinking alcohol in the past year.
Consider the following data set:
gender, race, ppl_quit
female, white, 4
female, Hispanic, 5
male, white, 6
male, Hispanic, 7
So the dataset will evaluate the values entered by the user for race and gender and find a matching line in the CSV file and provide the user with a value for the variable ppl_quit. Assuming that you have already uploaded your dataset, the next steps are as follows:

Create pages that ask the user to input/select a value. You can use the above example and ask the user for their gender and race. Next, you want the user feedback. To do this, on a new page, select Add Block->Output Block->text.

To present the user with values they entered previously, enter the variable as:

_YourVarName_example: _gender_. Note that there is a double underscore before and after variable name. The YourVarName is the name that you used for the input block while asking the user for their gender.
So, in the output block, you would type something like: Previously, you said that you are a _race_ _gender_. (Note: The system will gather these values from what the user entered previously). According to our study, we have found that _pplquit_% of_race_ _gender_s quit drinking alcohol in the past year. So when the user takes the survey, they'd see: Previously, you said that you are a white female. According to our study, we have found that 6% of white females quit drinking alcohol in the past year.
Please also note: for the CSV file to be able to import data successfully, YourVarName should match the column headers in the CSV file. Example: if you named your input block ‘gender,’ make sure that your CSV file has a column header ‘gender’ as well.
Data is evaluated from left to right in a CSV file.
Next, go to the ‘Sources’ tab and select ‘New’ from the ‘Sources’ drop down menu. Enter the name of your dataset and click ‘Create.’ Unlock your dataset, click on ‘Data Has Headers,’ select URL and copy and paste the URL of your file in the textbox.

Use the Dataset

The pages that ask for user input to evaluate a data file and the pages that give the user feedback need to be in different sections. The reason for this is that when you assemble a booklet, you will need to add a branch for the dataset. Datasets are only evaluated at the end of a section and the resulting variable values are available to use in the sections that follow.

Put the gender and race page in one section and the feedback page in another section.

When you are ready to assemble your booklet, go to the booklets, assemble sections and add a branch to the first section. Unlock your booklet, click on the first section, and then click on ‘Add Branch’ drop-down menu. Select Dataset. Edit the branch and select ‘Your Source’ from the drop-down menu.

Sections

Once you are finished creating the pages, the next step is compiling those pages into sections. A section may consist of a single page or multiple pages. It is up you as the survey designer to decide that.

A common question is, why do I need to compile the pages into sections? Why cannot I simply compile the pages into a booklet? Besides the fact that the software does not allow you to do that, there are a couple of advantages to ‘Sections.’ Consider the following scenarios:

A survey can be built for both men and women. However, some sections can be completely focused on women. In that case, you would not want men to answer questions like: “are you pregnant?” or “when was your last period?” By compiling pages into sections and then adding branching onto it, you can decide if an individual will see a particular set of pages (a section) based on their answer to the question, “What is your gender?” You can do this because an individual's gender is stored as a variable and you can use it to decide which section the user will see next or which section the user will not see at all. Likewise, you can do that with other variables like: age, race, amount of alcohol use, etc. Another advantage is that this arrangement allows you to deliver targeted feedback to users based on their use or abuse of a particular item. Sections connect to each other via branches in a survey. So, if one page is supposed to branch of off another page, it's probably not a good idea to put both those pages in the same section. It is important to note that the variable values (a person's gender etc.) are only available to use outside of the section. That is, you cannot branch inside sections.

FIG. 30 demonstrates what the ‘Sections’ tab looks like. You can see that it is divided into three general areas:

On the left is a list of sections. Next to it is the ‘Actions’ column. You can unlock a section, edit it or delete it. It is important to save the changes that you make to a section. You can see that the section ‘age1’ is highlighted (meaning selected). It is unlocked so that it can be edited.

In the middle are a list of pages that belong to the selected section, ‘age1.’ Also notice the ‘Actions’ column next to it. If there were multiple pages, you could arrange the pages sequentially (which will appear first and so on) by using the up and down arrows. If you click on the pen shaped icon next to the down arrow, you are taken to the page so that you can edit it. Lastly, you can also remove a page from the section by clicking on the arrow pointing towards the right.

On the right, you can see a list of all the pages created thus far. You can use the left and right arrows on the bottom to go forward or backward to browse the list of pages. Again, notice the ‘Actions’ column. The left arrow, allows you to add a page to the unlocked section. The pen shaped icon allows you to edit that page. It is important to note that you can only delete a page here by clicking on the trash can icon. Also note that once you delete the page, you cannot retrieve it.

Create a New Section

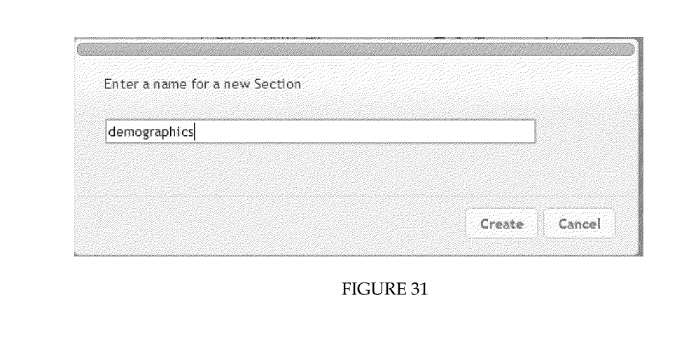

Suppose the user wants to create a demographics section that will contain all the pages that ask questions about an individual's age, race and gender. To create a new section, click on the drop-down menu button on the left side. A drop down menu appears; click on ‘New.’ FIG. 31 is a representation of a new window appears and asks you to enter the name for the new section. Enter ‘demographics.’

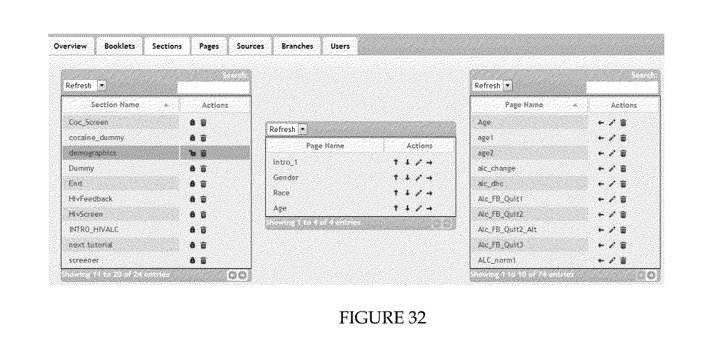

Click on ‘Create’ and you have a new section. Next, use the left and right arrows to find your section in the list of ‘Sections.’ Once found, unlock it and add pages to it. Finally, click on the left arrow next to the page name in the ‘Pages List’ to add it to the section. FIG. 32 shows that a few pages have been added to the demographics section.

Create a Booklet

The final step to creating a survey is to compile all your sections into a booklet and create branching on those sections. Let's use the example of an already created survey to demonstrate that. Navigate to the ‘Booklets’ tab. FIG. 33 demonstrates what the booklets tab looks like.

On the left side, there is a list of already created booklets. Next to it is the ‘Actions’ column where you can unlock a booklet to edit it, delete it, or create a survey map. In the middle is the ‘Sections’ column. Next to the ‘Sections’ column is the ‘Actions’ column. When a booklet is unlocked, you can add sections to it. Select the first section in the booklet and edit that section. The ‘Branching’ column is on the extreme right and you can use it to add a branch to a section.

FIG. 34 shows that the booklet ‘AleCoc’ is selected and unlocked. You can see that some sections have a checkmark next to them while some others have a dot next to them. The sections with a checkmark are the sections that are a part of the selected booklet—in this case, it is the ‘AlcCoc’ booklet.

In the ‘Sections’ column, notice the highlighted section, that is, ‘next tutorial’ section. It has a checkmark, and next to it is a little circle. The little circle indicates that this is the first section in the booklet.

Branching is used to decide which section a user will see next. A user may or may not see all the sections within a booklet (survey). The sections the users see are the ones that are applicable to their particular situation. Other sections are skipped.

As with all other objects, you can create a new branch, edit an existing branch, or delete it entirely. The invention system software comes with three kinds of preset Branches, but the user can create others if they so desire:

Not Optional: A ‘Not Optional’ is used when one section is going to follow another section in all scenarios. A good example of that would be the end section. You want every user to see that section. In order to do that, add a Not Optional′ branch to the section preceding the end section. This is one of the types of branching is used to decide which section will come next.

Dataset: A dataset branch is added so that the system can evaluate variables to be used later in the survey. For example, if you want to create a bar chart that compares an individual's alcohol use to the average for their age, race, and gender, upload a CSV file so that the invention system can evaluate it. It is considered best practice to add dataset branches as early as possible in the booklet as soon as the variables required to evaluate the dataset are available. This type of branching adds variables to the dataset which are used to give targeted feedback to the users. Targeted feedback means feedback that is based on the user's inputs (ex: race, gender and other variables like that.) While this type of branching does not directly decide which section will come next, it can be used to add tremendous amounts of normative data to allow quite complex branching decisions to follow. This is an ability unique to the invention system product, and it not only allows a booklet to remain simple in content while accessing complex external data—but that external data can be up-to-the-minute and still control much older Booklets.

Boolean: This the most complicated of the built-in types of branching. Boolean branching is based on variables that you define in the Pages (example: gender, race, and age) and the user answers. The invention system will store these variables and make them available to a branch after the section is over. Branching will use the variables as directed to determine which section the user will see next. A common example is that of a user who answers that he/she doesn't drink alcohol. In that case, you will not show them the feedback pages designed to give feedback for alcohol users. Therefore, those sections will be skipped for that user. It uses simple logic statements that anyone can quickly learn how to use.

Custom Branching: The invention system has the capability to allow the user to create arbitrarily complex branch descriptions and store them by name to be used later in multiple places. This could be used to more easily support branching choices controlled entirely by external data sources. The maintainers of the external datasets could maintain several custom branches that the booklet designers could then simply consume without needing to understand the nuances of the external dataset.

Please note that the branching language is actually JavaScript; evaluation results must be only true or false.

Create a New Branch

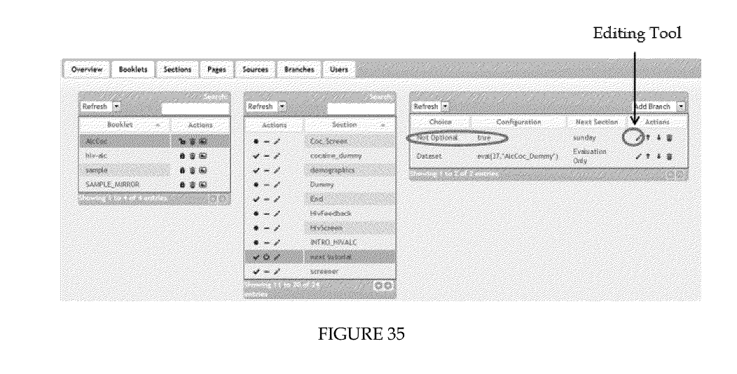

FIG. 35 is a representation of a computer screen that might be presented when the user is creating a new branch. Here are the steps to be followed to create a new branch: Navigate to the ‘Booklets’ section

Click on the lock button next to the booklet you want to edit. Unlock the booklet.
Click on the section you want to add branching to. If you've previously added any branches to that section, you'll see them pop up when you select a section.
Let's start with adding a Dataset branch to the very first section of our survey. Select the first section in your booklet.
Click on the ‘Add Branch’ button on the top right hand side. A drop-down menu appears. For now, select the ‘Not Optional’ branch. A branch will be added to the list of branches for that section like in FIG. 35.

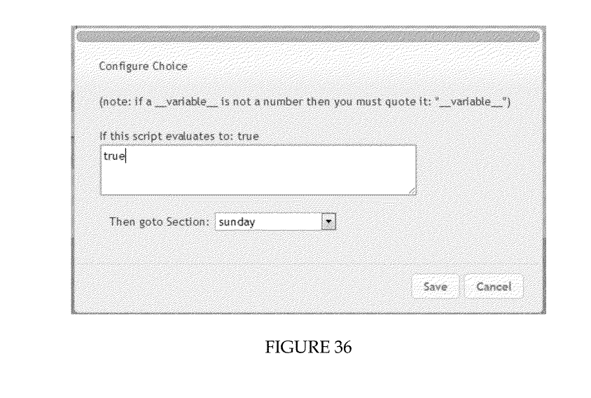

A new window will appear as the user clicks on ‘Editing Tool.’ FIG. 36 is a representation of that.

In the window in FIG. 36, notice the window where you can type your code. But for this type of branching, you do not need to do anything. Just leave ‘True’ typed in as is. Pick the section that you want from the drop-down menu next to the ‘Then go to Section.’ Remember that this is a ‘Not Optional’ branch. So all you have to do is pick a section of your choice.

Next, let's see how to add a dataset branch. Remember in the ‘Sources’ section, you learned how to upload a dataset source. Now that you have the source uploaded into system, all you have to do is add it to your survey as a dataset branch.

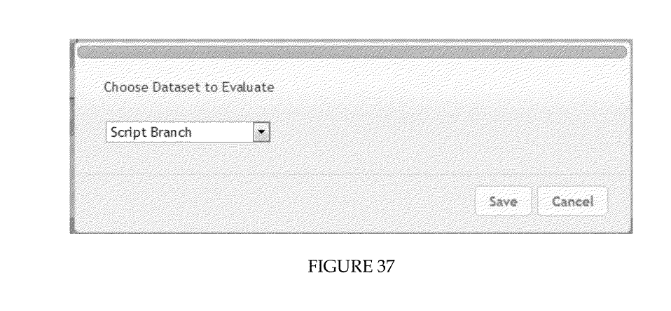

Select the ‘Dataset’ branch from the ‘Add Branch’ drop-down menu.
A dataset branch will be added to your section
FIG. 37 is a representation of a new window that might appear.
From the drop-down menu ‘Script Branch,’ select the name of your source and hit ‘Save.’

Next, you will see how to add a Boolean branch to your section of choice. As explained above, a Boolean branch is used to choose which section a user will see next based on their responses to certain questions.

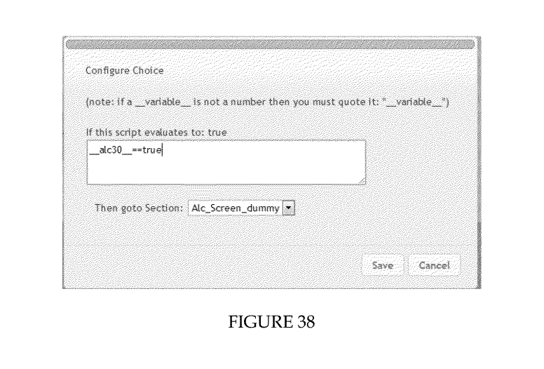

To add a Boolean branch to a section, go to ‘Add Branch’ drop-down menu and select Boolean.
A Boolean branch will be added.
In this case, use variable alc30′ to record a user's response to the question, “Have you used alcohol in the last 30 days?” If the user answers ‘yes,’ then they see will follow-up questions about the amount of alcohol usage. If they answer ‘no,’ then that entire section can be skipped for that user.
Click on the ‘Edit’ button so that you can edit the branch.
FIG. 38 is a representation of a window that might appear after clicking on the ‘Edit’ button to edit the branch.
In the code above, if ‘alc30’ evaluates to true, then the user will see the section, ‘Alc_Screen_dummy.’
Please note that you need to add double underscore before and after the variable name. Also note two equal-to signs.

FIG. 39 is a representation of a visual that might be presented the user if there is more than one branch in a section. The user can decide which branch gets evaluated first. The variables will be evaluated in the order as represented in FIG. 39. If the user wants to move a branch up or down, they can use the up or down arrows. The branch at the top gets evaluated first and then the other branches, in turn.

Map of the Survey

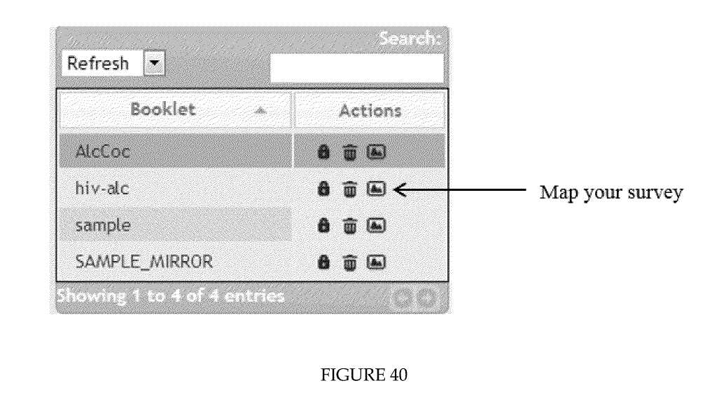

The invention system has a feature where you can see a map of the survey. That is, you can see how the survey is structured based on the various branching options. This is very useful since it puts the survey structure in a graphical form.
On the ‘Booklets’ tab, if you click on the ‘map your survey’ option, you can create a map of the survey. FIG. 40 a representation of a computer screen that shows where the ‘Map Your Survey’ option is.

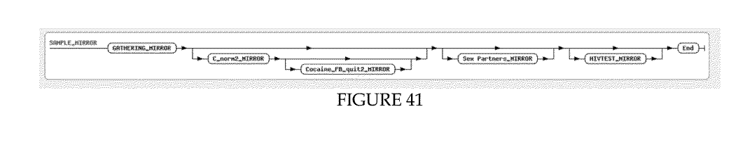

FIG. 41 is a representation of a sample survey map. It shows an example of what typical survey maps would look like.

Testing the Survey

Once the first draft of your survey is ready, the invention system lets you test your survey so you can see what it would look like to the user. It is always a good idea to work out the kinks in the survey before you administer it in real-time. Sometimes things do not work out the way you want them to. Before you can test your survey, you will have to generate a test code.

Generate a Test Code

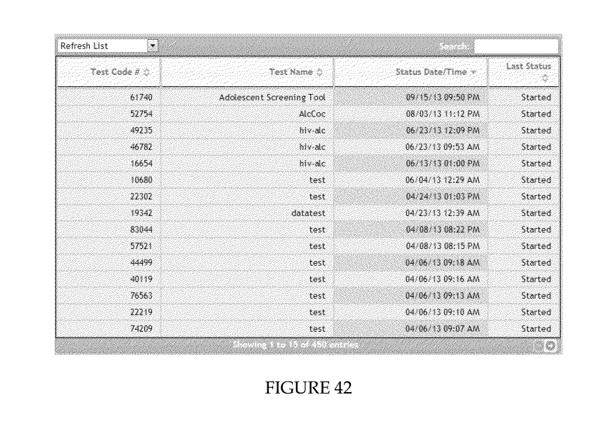

The user can go to the invention system website and select ‘To Proctor a Live Questionnaire, Click Here’ to generate a test code. FIG. 42 is a representation of a window that might appear to the user after making that selection. On the top, you can see a drop-down menu that says ‘Refresh List’. Select ‘Administer New Test’ if you're testing the survey for the first time. This will prompt a new window.

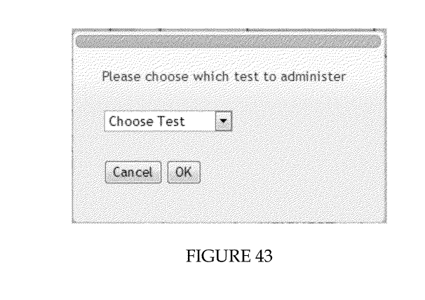

FIG. 43 is a representation of a window that the user might be prompted to test the survey for the first time. From the drop-down menu, select your survey. A new test code will be generated and stored here for you. Next time, you want to test your survey, you can retrieve your test code from here.

If the user already has a test code, the user can go back to the invention system website and select ‘If you have a TestCode already, Click Here (*test code required).’ A new window will appear again.

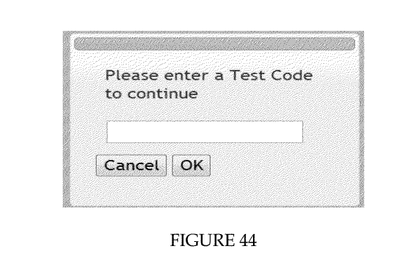

FIG. 44 is a representation of a window that the user might be prompted to test the survey if he has a Test Code already. The user can enter the test code in the window and click OK. Next, the user will be able to go through the survey and enter responses exactly as a new user would.

Where the Data from Surveys is Stored

An internal database is created of screening information collected from user responses to input blocks. All user responses to input blocks are stored internally; they can then be readily incorporated into content allowing for targeted feedback based on respondent characteristics.

1. A computer implemented method for treatment of addictive behavior comprising using an computer-stored custom survey-building software to build custom electronic patient surveys and administering said surveys to patients on a computer and for electronically delivering feedback to said patients as they are completing said electronic surveys based on patient responses to survey questions.

2. A method according to claim 1, further comprising dynamically increasing the patients working set of named variables by choosing and adding arbitrary numbers of new named variables from pre-defined external sets of normative data, wherein selection of the proper data to add is determined using the patients pre-existing named variables.

3. A method according to claim 1, further comprising an online method of defining charts, which can include any named variable, wherein said charts to be usable during the normal flow of a patient's path through a booklet survey, and to optionally contain values obtained from external normative data sets.

4. A method according to claim 1, further comprising a method for visually charting booklet surveys, wherein the internal branching structure of a booklet survey is a mappable superset of all the branch options (syntax diagrams, also known as railroad diagrams, are well suited to this use), wherein railroad syntax diagrams are used to visually display all the possible branch options for any given booklet survey, and wherein a picture icon is displayed on each line of the list of booklet surveys, next to the booklet name, and wherein clicking on the picture icon will cause the associated diagram to be displayed along the bottom of the screen.

5. A method according to claim 1, comprising a method for defining survey booklet branching choices that can be maintained in tandem with external normative data sets, comprising a cooperating method for booklet creators to use custom-defined branch options without needing to understand their logic.

6. A method according to claim 1, comprising a method for accumulating patient survey responses chronologically wherein patient responses are stored using a stack pattern and responses are tagged with the current page number.

7. A method according to claim 1, comprising a method for deleting patient survey responses in reverse chronological order as the patient moves backwards through the survey their previous responses are deleted as the page counter decrements.

8. A method according to claim 1, comprising a method for inserting prior responses into later booklet survey pages wherein all input blocks are named and patient entered variables are tagged with those names as input and output blocks are rendered on each page they are examined for tag replacement opportunities, and wherein tag replacements are performed as input and output blocks are rendered on each page.

9. A method according to claim 1, comprising a method for defining and storing input and output blocks on the survey page using the outer HTML element attribute, pre&post storage routines to handle exceptions and encoding of the full page data to smooth the storage and retrieval of pages.

10. A method according to claim 1, comprising a method of using patient inputs to determine which section of the booklet is to be displayed next.

11. A method according to claim 1, comprising a method of displaying patient inputs in subsequent pages as outputs for discussion.

12. A method for proctoring booklets surveys anonymously wherein the type of booklet survey is selected by the staff member, wherein a non-repeating id number is returned and entered manually into the survey tool, wherein all results are stored under the non-predictable, non-repeating id number, and wherein there is no provision for recording a connection between the given id number and the patient.
